(19) United States
(12) Patent Application Publication
(10) Pub. No.: US 2023/0398437 A1
(43) Pub. Date: Dec. 14, 2023

(54) METHOD AND APPARATUS FOR GAME PLAY

(71) Applicant: Wizard Tag LLC, Grand Forks, ND (US)

(72) Inventors: Jon Richard Fisher, Grand Forks, ND (US); Cally Joy McConnell, Grand Forks, ND (US)

(73) Assignee: Wizard Tag LLC, Grand Forks, ND (US)

(21) Appl. No.: 18/206,180

(22) Filed: Jun. 6, 2023

Related U.S. Application Data
(60) Provisional application No. 63/350,837, filed on Jun. 9, 2022.

(51) Int. Cl. A63F 13/235; G06F 3/0346; G06F 3/01

(52) U.S. Cl. CPC A63F 13/235; G06F 3/0346; G06F 3/017; A63F 2300/1031

(57) ABSTRACT

A game play device includes a gesture detection system that utilizes a single inertial measurement unit (IMU) and associated gesture detection software executing on a processor of the game play device. Unique gesture movements as detected by the game play device may be construed as menu navigation and control commands used to select audible, visible and tactile features relating to the game play device as well as game play modes executed by the game play device. The game play device immerses the user into an authentic game play experience using aesthetic qualities and multi-dimensional capabilities that are imagined to be those consistent with authentic magic wands used by actual wizards.

A portion of the disclosure of this patent document contains material which is subject to copyright protection. The copyright owner has no objection to the facsimile reproduction by anyone of the patent document or the patent disclosure, as it appears in the U.S. Patent & Trademark Office patent file or records, but otherwise reserves all copyright rights whatsoever.

### FIELD OF THE INVENTION

The present invention generally relates to game play devices, and more particularly to realistic, motion-controlled game play devices.

### BACKGROUND

Game play devices have been traditionally utilized for physical recreational activity for two or more people at a multitude of venues, such as at home, outside or family entertainment centers. Conventional game play devices are generally further designed for use within a simulated combat environment, where the game play device may be disguised as a handgun, small arm or in a variety of other weaponry formats.

In order to simulate munitions discharge, many conventional game play devices utilize emissions of collimated beams of infrared (IR) light that are directional so that they may be targeted by one participant against one or more of the remaining participants in the game play. Each participant must further employ wearable IR light sensors that may be used to detect IR light that may be incident upon a particular body part (e.g., head or torso) of each participant. Further, the IR light emissions may be encoded with identifying information about the participant and/or the participant's game play device such that when the emitted IR light is detected by the receiving IR light sensor, so is the data encoded within the IR light emission. Accordingly, at the end of game play, each participant may be able to accumulate statistics relevant to the game play, such as the number of “hits” received by the wearable sensors of the participant as compared to the number of “hits” administered by the participant against the remaining participants of the game play.

Conventional game play using conventional game play devices, therefore, may be somewhat mundane since the statistics relating to game play performance are limited mainly to the number of “hits” received by a participant's clothing mounted sensors as compared to the number of “hits” administered by that participant and such statistics are traditionally only gathered once game play has concluded. Accordingly, the results fail to be multi-dimensional and are rather binary in their nature since the “winner” of the game play may simply be declared as that participant receiving the fewest number of “hits” on their wearable sensors in one example, or in another example, the winner of the game play may be that participant who delivered the greatest number of “hits” against his or her opponents.

Further, conventional game play devices include imperfections that inherently divulge their identity as a toy rather than as a genuine article. For example, conventional game play devices utilize poor quality materials and inferior manufacturing techniques that highlight certain abnormalities and imperfections, such as visible input/output (I/O) control components (e.g., on/off switches) and manufacturing flaws (e.g., snap-together sub-components) that divulge interface seams defining each location where one sub-component interfaces with another sub-component of the game play device. Such imperfections detract from the immersive quality of conventional game play devices.

Efforts continue, therefore, to develop realistic game play devices with superior aesthetic qualities and multi-dimensional game play capabilities to better immerse each participant into an authentic game play experience without the need to augment the game play device with additional components external to the game play device.

### SUMMARY

To overcome limitations in the prior art, and to overcome other limitations that will become apparent upon reading and understanding the present specification, various embodiments of the present invention disclose multi-dimensional game play methods and realistic, high-quality game play devices for use therewith. Game play devices in accordance with the present invention may be made to mimic genuine articles having increased functionality for game play utility as well as for non-game play utility. Game play devices in accordance with the present invention may further provide enhanced user feedback (e.g., audible, visible and tactile feedback) with enhanced motion detection during game play so as to provide a more immersive game play experience.

In accordance with one embodiment of the invention, a game play device comprises an outer structure formed to mimic a magic wand. The outer structure is configured to conceal internal components of the game play device. The internal components of the game play device include a single inertial measurement unit (IMU) configured to detect movements of the game play device and a processor configured to construe the movements as commands. The processor uses the commands to control one or more operational modes of the game play device.

In accordance with an alternate embodiment of the invention, a method of detecting movement of a game play device comprises determining roll, pitch and yaw values using acceleration and gyroscopic data collected within a coordinate frame of a game play device, filtering at least one of the determined roll, pitch and yaw values, compensating for reduced magnitudes of the gyroscopic data when the roll value resides within a transition region, normalizing the accelerometer and gyroscopic data to the determined roll value, excluding yaw values when the game play device exhibits verticality and registering the detected movements as command gestures.

In accordance with an alternate embodiment of the invention, a gesture detection system comprises an inertial measurement unit (IMU) and a processor coupled to the IMU. The processor includes a gesture detection module coupled to the IMU. The gesture detection system further comprises a memory coupled to the gesture detection module. The memory is configured to store a sequence of detected gesture steps and a plurality of gesture step templates. The gesture detection module is configured to determine a first proximity difference between the sequence of detected gesture steps as compared to at least a first portion of the plurality of gesture step templates.

### BRIEF DESCRIPTION OF THE DRAWINGS

Various aspects and advantages of the invention will become apparent upon review of the following detailed description and upon reference to the drawings in which:

FIG. 1 illustrates an isometric view of a game play device in accordance with an embodiment of the present invention;

FIG. 2 illustrates a block diagram of a game play device in accordance with an embodiment of the present invention;

FIGS. 3-6 illustrate control gestures implemented by a game play device in accordance with embodiments of the present invention;

FIG. 7A illustrates a coordinate system used to describe movements of a game play device in accordance with one embodiment of the present invention;

FIG. 7B illustrates a gesture detection block diagram used to detect the movements of a game play device within the coordinate system of FIG. 7A in accordance with one embodiment of the present invention;

FIG. 8 illustrates a diagram describing roll values exhibited by a game play device in accordance with one embodiment of the present invention;

FIG. 9 illustrates a gesture detection flow diagram in accordance with one embodiment of the present invention;

FIGS. 10A and 10C illustrate complex gestures in accordance with one embodiment of the present invention;

FIGS. 10B and 10D illustrate templates comprising a series of preselected sequences that approximate the complex gestures of FIGS. 10A and 10C, respectively, in accordance with one embodiment of the present invention; and

FIGS. 11, 11A, 12, 13, 13A, 13B and 14 illustrate printed circuit board assemblies of a game play device in accordance with several embodiments of the present invention.

### DETAILED DESCRIPTION

Generally, the various embodiments of the present invention are applied to methods of implementing game play activities and the game play devices for use therewith. In one embodiment, a game play device may genuinely mimic a magic wand by virtually removing from sight any mechanical discontinuities and imperfections thereby better mimicking a genuine article. Furthermore, while the game play device of the present invention includes many lighting, sound and haptic effects that may be adjustable by the user, no visible input/output (I/O) devices may exist for adjustment. Rather, certain external components of the game play device may be manipulated by the user to expose the I/O devices from an otherwise stealthy existence in order to gain access to such I/O devices. Conversely, the need for certain I/O devices may simply be obviated due to the increased controllability (e.g., gesture detection) of the game play device.

The game play device may, for example, employ enhanced motion detection through the use of a single device (e.g., inertial measurement unit (IMU)) and enhanced gesture detection to control both game play and non-game play functionality. Accordingly, the need for more than one detector (e.g., accelerometer or IMU) and the associated relative motion measurements of the multiple detectors is obviated.

Navigation of the multiple menus available within the game play device or assistance during game play may be accomplished through the use of motion-controlled commands generated by one or more user-initiated movements of the game play device as may be detected via absolute one-dimensional, two-dimensional and/or three-dimensional measurements taken from a single device (e.g., IMU or accelerometer) contained within the game play device. As per one example, movements that simulate a two-dimensional drawing (e.g., as if the game play device were being utilized to draw a two-dimensional figure onto an imaginary surface defined by the X-Y, Y-Z and/or Z-X coordinate planes) may be detected by a single IMU of the game play device and translated by a processor contained within the game play device into menu navigation commands that may allow the user of the game play device to traverse various operational modes provided by the game play device and/or to receive audible assistance cues before and during game play. Alternately, certain commands may be initiated by the user via three-dimensional movements (e.g., as if the game play device were being utilized to create a three-dimensional figure within a volume defined by the X-Y-Z coordinate space) that may be similarly detected by a processor located within the game play device using, for example, three-dimensional measurements taken by a single device (e.g., IMU or accelerometer).

Additionally, the IMU may provide information relating to the linear movement (e.g., linear velocity and linear acceleration) of the game play device and/or the rotational movement (e.g., angular velocity and angular acceleration) of the game play device. Accordingly, detection of the absolute position, velocity and/or acceleration parameters used to transcribe the two-dimensional and/or three-dimensional motion commands may be used to provide further control information relative to the operational state of the game play device.

Immersion of the user into fantasy game play may be effectuated by physical cues (e.g., visible, audible and tactile feedback) as generated by the game play device. For example, visible cues (e.g., via light generated by light emitting diodes (LEDs) from an interior of the game play device) may be implemented to provide the user with real-time game play statistics within a given match, such as for example, whether the user sustained a “hit” or blocked a “hit.” Further, the game play device may record statistics relating to the game play, such as the number of “hits” administered by the user, the number “hits” sustained by the user, the number of would-be “hits” successfully shielded by the user and may then provide such statistics to support a final report at the end of a match. Visible, audible and/or tactile cues may also be utilized by the game play device to, for example, provide confirmation of special character selection (e.g., whether the participant wishes to select himself/herself or another participant as a team leader or master wizard) within a given match.

Audible cues may, for example, be utilized by a user of the game play device to obtain audible instructions from the game play device in response to a user-initiated command (e.g., two-dimensional or three-dimensional movements recognized by the game play device as a request from the user for audible instructions before and/or during game play). Alternately, a game play device (e.g., a magic wand) may be waved by the user in proximity to a game play prop (e.g., a dragon egg) that may detect the presence of the magic wand (e.g., via near-field communications (NFC) protocol) and in response communicate wirelessly (e.g., via Wi-Fi, NFC, Bluetooth, Bluetooth mesh or thread-based mesh) to the magic wand, which may then convert the wireless communication to audible cues (e.g., instructions as to how to capture the dragon egg) to the user's advantage during game play (e.g., how to keep the dragon egg from capture by the other participants of the game play).

Tactile cues (e.g., vibration), for example, may be generated by the game play device during game play to further immerse the user into the fantasy game play experience. As per one embodiment, the game play device may vibrate to indicate a transition from sleep mode into standby mode, to indicate the start of a match, to indicate navigation through settings menu items, to cast a spell or any other operational mode indications that may be useful. Operational statistics may further be communicated via vibration to indicate, for example, a “hit” received from an opponent, blocking a “hit” that would have otherwise been received from an opponent, the depletion of life sustenance (e.g., mana) or the receipt of mana.

As per an alternate embodiment, directional gyroscopic forces may be generated from within the game play device that may be utilized to point the game play device along a vector that may indicate the location of a game play prop (e.g., a dragon egg or secret passageway) and thereby guide the user of the game play device toward the game play prop. As per an alternate embodiment, tactile cues (e.g., generated by a vibration motor or piezo-electric device) may be activated from within the game play device to communicate to the user during game play (e.g., a combination of short and long bursts of vibration to generate a Morse Code message) that may then be used by the user to modify his or her actions (e.g., utilize the message as a clue during a scavenger hunt) as a part of game play.

In order to conceal internal electronic devices (e.g., LEDs) from external view of the game play device, light pipes (e.g., fiber-optic cable) may be utilized within an interior of the game play device such that light may be delivered to orifices (e.g., holes and cracks that may naturally exist within a game play device that mimics a magic wand) without disclosing to the user the existence and location of the LED within the game play device. In one embodiment, light (e.g., broadband white light) may be generated from within the game play device and routed via a light pipe to perform a non-game play activity (e.g., providing illumination reminiscent of a flashlight). In an alternate embodiment, light may be delivered to orifices of the game play device such that optically significant attachments (e.g., snap-on diffusers) may be attached to such orifices and may be utilized to alter the emitted light (e.g., alter the direction and/or color of the emitted light) in order to provide game play communication to the user or to provide other special effects during game play. Alternately, LEDs within the game play device may include LEDs capable of emitting programmable colored light.

Ultraviolet (UV) light may be generated from within the game play device and routed (e.g., via light pipe) to perform game play activities (e.g., illuminating invisible ink inscriptions or creating lighting effects in a rave). Alternate devices may, for example, attach to the exterior of the game play device in such a manner as to facilitate receipt of light generated from within the game play device (e.g., infrared (IR) light generated by an LED) and propagate the received light to an exterior of the game play device (e.g., along a shaft of a magic wand) in an optically significant manner (e.g., diffusing/collimating the light into specific light distribution patterns) to, for example, generate short-range wide bursts and long-range narrow bursts, respectively, of IR light. Alternately, IR light distribution patterns may be effectuated simply by selecting IR emitters (e.g., LEDs) with secondary optics designed to generate the desired distribution pattern widths.

Game play devices in accordance with the present invention may not only accumulate game play statistics, but may also communicate such game play statistics to other game play devices during game play and/or at the end of game play. As per one example, wireless communications (e.g., Wi-Fi, NFC, IR, Bluetooth, Bluetooth mesh or thread-based mesh) may be implemented within each game play device and may be utilized to allow the exchange of game play information between participating game play devices during game play to allow such information to be communicated (e.g., via visible, audible and/or tactile feedback) to the users of such game play devices. Such game play information may, for example, motivate those users who may be lagging behind the leading scorers to increase their level and/or quality of game play. Alternatively, game play statistics may only be communicated at the end of game play, so as to increase the suspense that may be gained by delaying the ultimate game play tally.

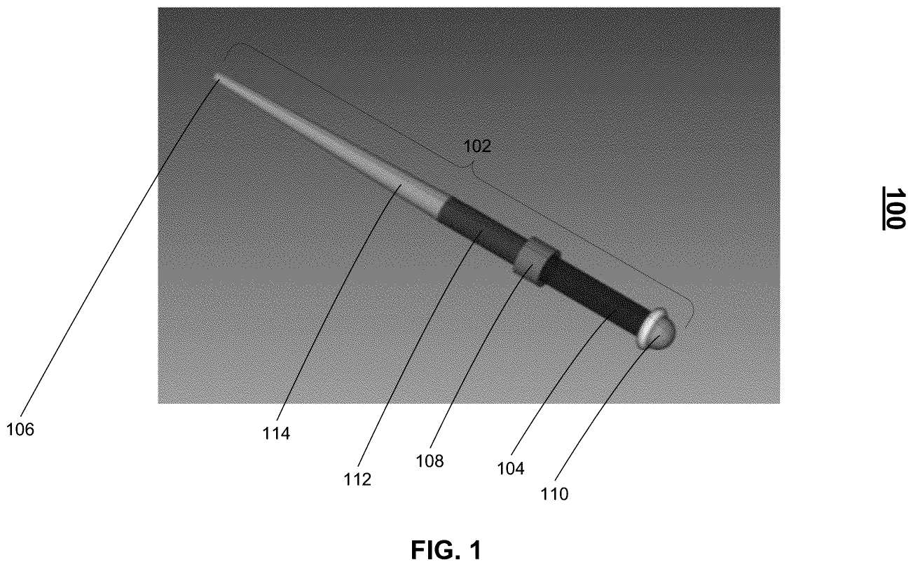

Turning to FIG. 1, a top perspective view of game play device 100 is exemplified, which in one embodiment may include features resembling a magic wand. It is understood that game play device 100 may be manufactured to resemble virtually any size, shape and/or type of game play device and may further be manufactured to allow a user of the game play device to modify aesthetic features of the game play device per their desires. As per an example, attachments (not shown) may be used by the user to change the texture, design and/or color of the shaft, handle and pommel of the game play device. Manufacturing techniques (e.g., injection molding) may further be utilized during production of game play device 100 to, for example, minimize imperfections (e.g., interface seams) thereby increasing the authentic nature of the game play device so as to further enhance the immersive game play experience for the user.

A game play device (e.g., magic wand 100) may, for example, exhibit an overall length 102 of between fifteen to nineteen inches (e.g., approximately 17 inches) or between fifteen to twenty inches (e.g., approximately 18 inches) and may range in girth from between one to two inches in diameter (e.g., approximately 1 inches in diameter) at handle 104 to between one-half inch and one inch in diameter (e.g., approximately ¾ inch diameter) at tip 106. Certain of the exterior features of game play device 100 may be utilized, for example, to conceal various I/O features, such as an on/off button (e.g., capacitive or contact-based switch not shown) and a charging port (e.g., USB-C interface not shown), that may be obscured (e.g., behind barrel 108 and/or cap (pommel) 110) and revealed upon manipulation (e.g., rotation of barrel 108) in order to allow access to such I/O features. Additionally, cap (pommel) 110 may be stylized in the form of a Celtic knot and may be configured to be optionally removed to reveal, for example, a programming/diagnostics port (e.g., a USB-C interface not shown). Alternatively, I/O features may be concealed within the geometry of game play device 100 using covers or surfaces for buttons and ports that match the surface of game play device 100. As per an example, the USB-C interface (not shown) may be hidden beneath a flexible sleeve fitted over handle 104 that may allow the on/off button to be activated without being seen and the USB-C interface to be covered by a portion of the sleeve that may be partially cut out and connected by a living hinge.

In alternate embodiments, the need for certain I/O features may be obviated via detection of movement of the game play device in a particular manner. As discussed in more detail below, for example, detected gestures may instead be used by the game play device while in a sleep mode of operation to transition from sleep mode to active game play mode upon the occurrence of a particular detected gesture.

Game play device 100 may, for example, further include mechanical features that may facilitate audible, tactile and/or visible emissions. As per one example, cap (pommel) 110 may be arranged so as to allow the concealment of orifices that may be used to propagate sound generated from within game play device 100 (e.g., via one or more speakers not shown) that may then be heard by game play participants within proximity to game play device 100. Other orifices (not shown) may exist (e.g., along body portions 104, 112 and/or 114) that may allow the propagation of light generated from within the game play device (e.g., LED light) along a periphery of game play device 100 (e.g., along portions 104, 112 and/or 114), which may then be detected by users that are within proximity of game play device 100 and discerned by those users as coded outputs emitted by game play device 100 (e.g., command acknowledgments or game play statistics).

Game play device 100 may construe detected movements as motion commands, or gestures, that may activate features and provide access to operational menus executed by a processor (not shown) operating within game play device 100. In one embodiment, game play device 100 may include an IMU (not shown) that when combined with gesture detection software executed by a processor (not shown) of game play device 100, may detect such gestures and may cause game play device 100 to behave in accordance with the manner in which the detected gestures may be construed by game play device 100.

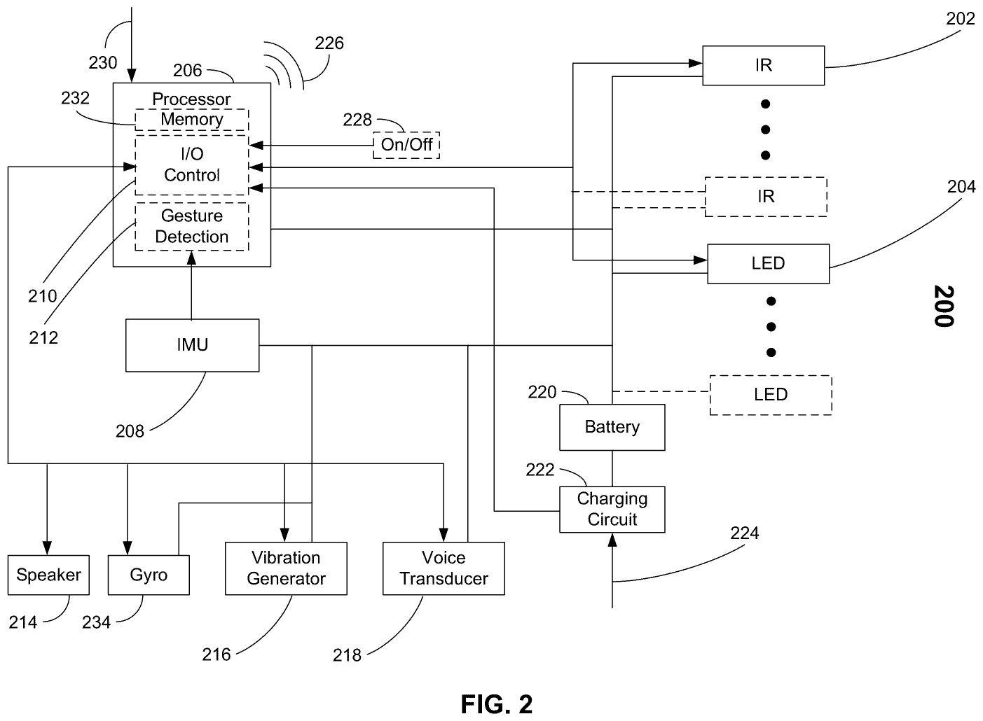

Turning to FIG. 2, block diagram 200 exemplifies functionalities that may be implemented within a game play device (e.g., game play device 100 of FIG. 1), which may include one or more IR receivers/transceivers 202, one or more light sources (e.g., individually addressable LEDs 204), a sound generating device (e.g., speaker 214), vibration generator (e.g., motor or piezo-electric device 216), a gyroscopic force generator (e.g., gyro 234) and a voice generation device (e.g., voice transducer 218 or recorded audio files stored within memory 232). A battery 220 (along with associated power regulation/conversion), charging circuit 222 and charging port (e.g., USB-C 224) may further be included to provide and maintain operational power. If operational power falls below a specific threshold (e.g., 15% capacity remaining within battery 220 as detected by charging circuit 222), user feedback (e.g., blinking red light emitted by one or more LEDs 202) may alert the user to the low power condition.

An on/off switch 228 (e.g., capacitive or continuity-sense switch) may be provided as well so as to activate the game play device for operation. In alternate embodiments, movement of the game play device in a particular manner (e.g., as detected by IMU 208 and construed by gesture detection 212) may instead be used to wake the game play device from a sleep mode of operation and transition the game play device to an operational game play mode.

A single IMU 208 may be provided, which may generate information relating to the orientation and/or movement of a game play device (e.g., game play device 100 of FIG. 1). Gesture detection 212 may include functionality (e.g., via executable machine code) to receive orientation and/or movement information from IMU 208 and to convert the received information into a perceived gesture movement, which may then be construed by processor 206 as the activation of game play device features and/or navigational commands for access to game play device operational menus executing within processor 206.

Processor 206 may include wireless interface 226 (e.g., Wi-Fi, NFC, Bluetooth, Bluetooth mesh or thread-based mesh) that may be used to communicate with other game play devices and/or game play props (e.g., dragon eggs, mana supply crystals, etc.) during game play. Wireless interface 226 may further be utilized to wirelessly communicate firmware updates to processor 206 and/or receive diagnostic information from processor 206. Conversely, an I/O port (e.g., USB-C port 230) may optionally be used instead for such purposes.

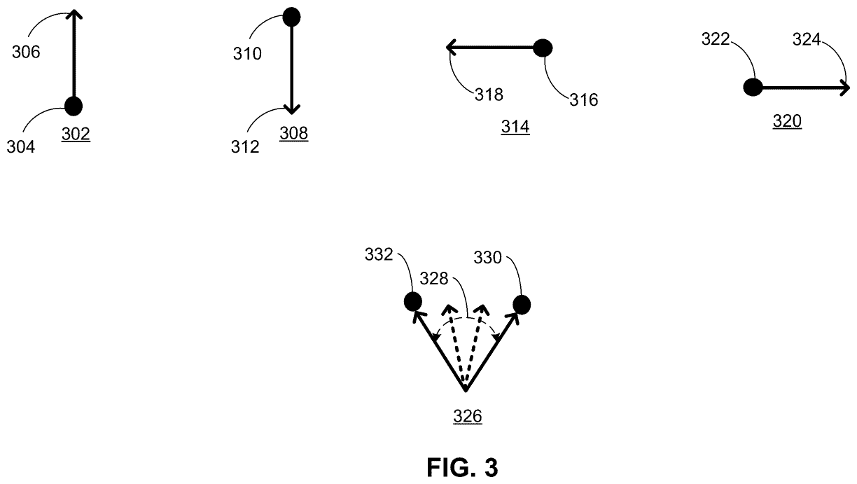

Turning to FIG. 3, various gesture movements are exemplified, which may generally be characterized as menu navigation commands having a starting position (e.g., as notated by a black dot) of a particular component of a game play device (e.g., tip 106 of game play device 100), which may then be followed by a gesture movement direction (e.g., as notated by a directional indication) originating from the starting position. It should be noted, for example, that the velocity and/or change in velocity (acceleration) by which a gesture movement may be traversed may provide additional control information as well.

As per one example, gesture movement 302 may be characterized by starting position 304 followed by upward movement 306 relative to starting position 304 (e.g., as detected by IMU 208 and gesture detection 212 of FIG. 2). In one embodiment, gesture movement 302 may be interpreted (e.g., by gesture detection 212 of FIG. 2) as a scroll command (e.g., “scroll up”), which may allow a user to navigate upward through operational menus executing within processor 206 and may cause feedback (e.g., a “woosh” sound emitted by speaker 214 of FIG. 2) so that the user may confirm successful upward menu navigation.

Similarly, gesture movement 308 may be characterized by starting position 310 followed by downward movement 312 relative to starting position 310 (e.g., as detected by IMU 208 and gesture detection 212 of FIG. 2). In one embodiment, gesture movement 308 may be interpreted (e.g., by gesture detection 212 of FIG. 2) as a scroll command (e.g., “scroll down”), which may allow a user to navigate downward through operational menus executing within processor 206 and may cause feedback (e.g., a “woosh” sound emitted by speaker 214 of FIG. 2) so that the user may confirm successful downward menu navigation.

As per another example, gesture movement 314 may be characterized by starting position 316 followed by leftward movement 318 relative to starting position 316 (e.g., as detected by IMU 208 and gesture detection 212 of FIG. 2). In one embodiment, gesture movement 314 may be interpreted (e.g., by gesture detection 212 of FIG. 2) as a scroll command (e.g., “go back”), which may allow a user to return to a previous operational menu as executed by processor 206 and may cause feedback (e.g., a “woosh” sound emitted by speaker 214 of FIG. 2) so that the user may confirm successful menu navigation.

Similarly, gesture movement 320 may be characterized by starting position 322 followed by rightward movement 324 relative to starting position 322 (e.g., as detected by IMU 208 and gesture detection 212 of FIG. 2). In one embodiment, gesture movement 320 may be interpreted (e.g., by gesture detection 212 of FIG. 2) as a control command (e.g., “select”), which may allow a user to select an option as presented by operational menus executing within processor 206 and may cause feedback (e.g., a “ping” sound emitted by speaker 214 of FIG. 2) so that the user may confirm successful selection of a menu option.

As per another example, gesture movement 326 may be characterized by starting position 332 followed by alternating left-to-right and right-to-left movements 328 relative to starting position 332 (e.g., as detected by IMU 208 and gesture detection 212 of FIG. 2). In one embodiment, gesture movement 326 may be interpreted (e.g., by gesture detection 212 of FIG. 2) as a control command (e.g., “cancel last selection” or “wake up” if in a sleep mode), which may allow a user to cancel the last menu or game mode selection as executed by processor 206 or wake the game play device (e.g., game play device 100 of FIG. 1) from a sleep mode of operation (e.g., very low power mode) that may be selected by processor 206 to conserve power while the game play device (e.g., game play device 100) is not participating in active game play. It should be noted that gesture movement 326 may instead be characterized by starting position 330 followed by alternating right-to-left and left-to-right movements 328 relative to starting position 330 in order to assert the same control command (e.g., “cancel last selection” or “wake up”).

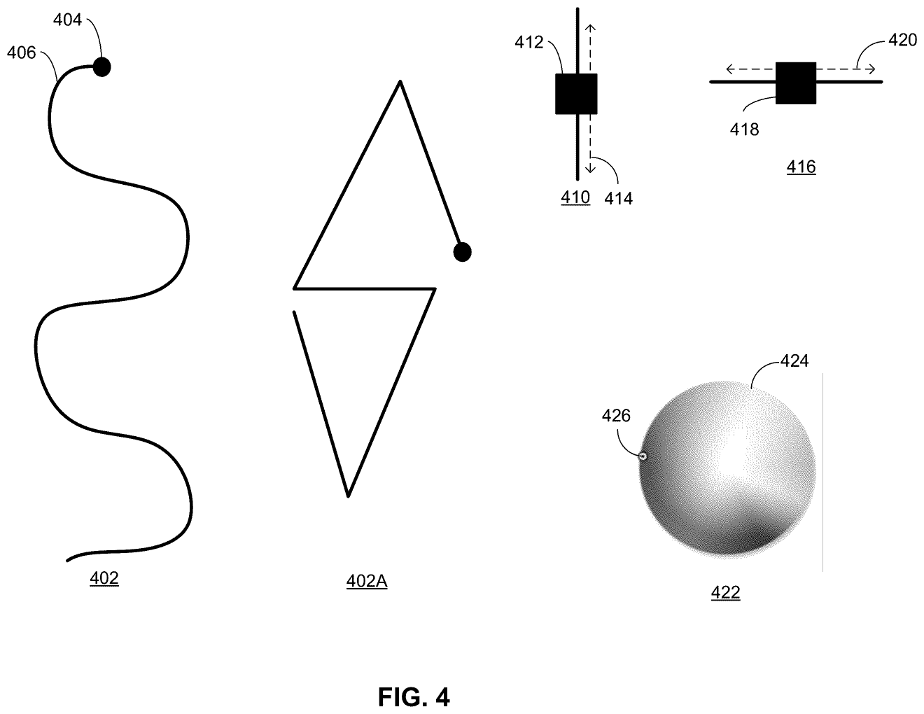

Turning to FIG. 4, various gesture movements are exemplified, which may generally be characterized as setting commands having a starting position (e.g., as notated by a black dot) of a particular component of a game play device (e.g., tip 106 of game play device 100), which may then be followed by a unique gesture movement (e.g., as notated by a unique gesture movement indication) originating from the starting position.

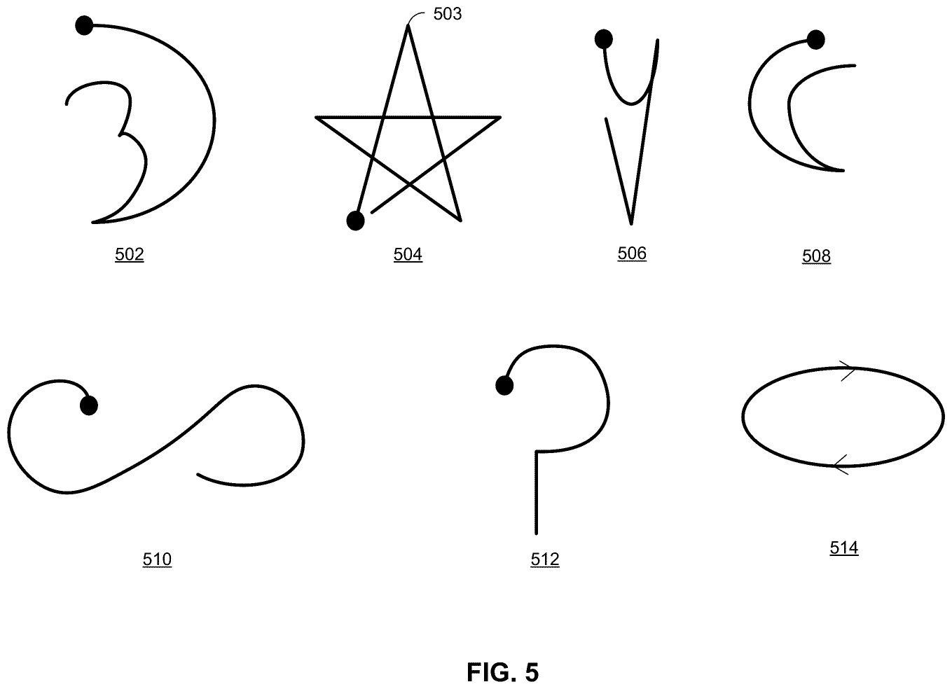

As per one example, gesture movement 402 may be characterized by starting position 404 followed by unique gesture downward movement indication 406 relative to starting position 404 (e.g., as detected by IMU 208 and gesture detection 212 of FIG. 2). In one embodiment, gesture movement 402 may be interpreted (e.g., by gesture detection 212 of FIG. 2) as a settings command (e.g., “enter settings mode”), which may allow a user to select certain operational parameters (e.g., audible volume, visible intensity, and visible color) that may be exhibited by certain I/O devices (e.g., LEDs 204 and speaker 214 of FIG. 2) of a game play device (e.g., game play device 100 of FIG. 1). It should be noted, for example, that gesture movement 402 may be detected as if it were drawn within any one or more of the two-dimensional planes (e.g., the planes defined within the X-Y, Y-Z and/or Z-X coordinate planes) and may cause visible feedback (e.g., white light twinkling emitted by one or more LEDs 202 of FIG. 2) and/or other forms of feedback (e.g., audible and/or haptic) so that the user may confirm successful entry into the settings mode of operation. The abrupt (e.g., discontinuous) changes in direction of gesture movement 402A may, for example, be used instead of the smooth (e.g., continuous) changes in direction of gesture movement 402 to minimize the likelihood of a false association with similar gestures (e.g., gesture 510 as discussed further in relation to FIG. 5).

Once processor 206 transitions to settings mode (e.g., via the settings mode command initiated by gesture movement 402 or 402A), the game play device may query the user (e.g., via an audible query issued via speaker 214 of FIG. 2) as to whether the user wishes to enter the volume sub-settings menu. The user may then cause the game play device to enter the volume sub-settings menu by using the “select” gesture. Generally, the user may navigate between menu options by using the “up” or “down” gestures (e.g., gestures 302 and 308, respectively, of FIG. 3). The user may enter any menu by using the “select” gesture (e.g., gesture movement 320 of FIG. 3). The settings menu options may control, for example, all volume settings, vibrations (haptic feedback), side lighting, and tip lighting. The volume menu may contain, for example, sub-menus for master volume, sound effects volume, muting/unmuting sound effects, voice guide volume, and muting/unmuting voice guide. The side lighting menu may contain, for example, sub-menus for brightness, color selection, and toggling side lights on/off. The tip lights menu may contain, for example, sub-menus for brightness and toggling tip lights on/off. Navigation away from any menu or sub-menu may be performed by invoking either the “left” gesture (e.g., gesture movement 314 of FIG. 3) or the “cancel” gesture (e.g., gesture movement 326 of FIG. 3).

Gesture movement 410 may be characterized by an imaginary slider 412 that may be moved up and down via the detected movements of certain components of a game play device (e.g., tip 106 of game play device 100 of FIG. 1). In one embodiment, gesture movement 410 may be interpreted (e.g., by gesture detection 212 of FIG. 2) as a volume control command (e.g., master volume up/down, sound effects volume up/down, voice guide volume up/down, etc.), which may allow a user to select the magnitude of volume produced by a sound producing device (e.g., speaker 214 of FIG. 2) of a game play device (e.g., game play device 100 of FIG. 1). It should be noted, for example, that while the user is utilizing imaginary slider 412 to adjust volume, the sound producing device (e.g., speaker 214 of FIG. 2) of the game play device (e.g., game play device 100 of FIG. 1) may provide audible feedback as to the currently selected volume magnitude, which may track the position of imaginary slider 412 up and down. As per one example, the user may hold the wand still for a period of time (e.g., approximately 3 seconds) to set the volume level. An audible tone may then be emitted to confirm the selection and the menu may advance back a level and proceed to the next option (e.g., the game play device may advance to the sound effects menu and ask if the user wants to enter that sub-menu). Sound effects and voice guide volume levels may be set in the same way as master volume as discussed above.

Once the user has landed on the last menu selection of the first settings control menu (e.g., volume settings menu), the user may continue to toggle through the remaining settings control menus by, for example, responding to audible prompts issued by the game play device. For example, a second settings control menu (e.g., vibration settings menu) may be prompted by the game play device by asking the user whether haptic feedback is to be enabled. In response, the user may either activate the haptic feedback option by issuing a “select” gesture (e.g., gesture movement 320 of FIG. 3) or may utilize the “go back” gesture (e.g., gesture movement 314 of FIG. 3) to deactivate the haptic feedback option and advance to the next settings control menu. A third settings control menu (e.g., sound effects menu) may then be prompted by the game play device by asking the user whether sound effects are to be enabled. In response, the user may either activate the sound effects option by issuing a “select” gesture (e.g., gesture movement 320 of FIG. 3) or may utilize the “go back” gesture (e.g., gesture movement 314 of FIG. 3) to deactivate the sound effects option and advance to the next settings control menu.

Other settings menus may control lighting based on their physical position on the game play device (e.g., side and tip lights), whereby the user may adjust brightness and color of the tip lights while further opting to toggle the side lights on or off. In one embodiment, gesture movement 410 may be interpreted (e.g., by gesture detection 212 of FIG. 2) as a light intensity control command (e.g., light intensity brighter/darker), which may allow a user to select the light intensity produced by a light producing device (e.g., LEDs 204 of FIG. 2 arranged at the tip) of a game play device (e.g., game play device 100 of FIG. 1). It should be noted, for example, that while the user is utilizing imaginary slider 412 to adjust intensity, the light producing device (e.g., LEDs 204 of FIG. 2) of the game play device (e.g., game play device 100 of FIG. 1) may provide visible feedback as to the currently selected intensity, which may track the position of imaginary slider 412 up and down.

A fourth settings control menu (e.g., color settings menu) may be selected by issuing gesture movement 422 within the surface area defined by imaginary color wheel 424 (e.g., two-dimensional movement within the X-Y, Y-Z or Z-X coordinate planes) may be interpreted (e.g., by gesture detection 212 of FIG. 2) as a light color control command (e.g., color of light emitted by the game play device changes as gesture movement 422 traverses the surface of imaginary color wheel 424), which may allow a user to select the light color produced by a light producing device (e.g., LEDs 204 of FIG. 2) of a game play device (e.g., game play device 100 of FIG. 1).

It should be noted, for example, that while the user is pointing the game play device (e.g., game play device 100 of FIG. 1) to a location (e.g., starting location 426 within imaginary color wheel 424), the light producing device (e.g., LEDs 204 of FIG. 2) of the game play device (e.g., game play device 100 of FIG. 1) may provide visible feedback as to the currently selected color. For example, color selection may start in the center of color wheel 424 within the RGB approximation of the color “white” and may move to other colors (e.g., the color “red” as selected by location 426) by tracking the position of the game play device within the confines of the surface area of imaginary color wheel 424 by changing the color of light emitted to match the color being selected as the game play device traverses the surface of imaginary color wheel 424. To select color, the user may hold the game play device still for an amount of time (e.g., three seconds) while waiting for a tone and/or vibration to be emitted by the game play device thereby freezing the current color selection while advancing to the next menu or sub-menu item.

Turning to FIG. 5, various gesture movements are exemplified, which may generally be characterized as miscellaneous commands having a starting position (e.g., as notated by a black dot) of a particular component of a game play device (e.g., tip 106 of game play device 100), which may then be followed by a unique gesture movement (e.g., as notated by a unique gesture movement indication) originating from the starting position. As per one example, gesture movement 502 may be interpreted (e.g., by gesture detection 212 of FIG. 2) as a volume control command (e.g., master mute/unmute), which may allow a user to mute all audio or unmute if already muted without the need to traverse the volume control settings menu as discussed above. Successful muting of volume may be indicated visibly (e.g., all LEDs 202 of FIG. 2 turn red and blink twice) while a visible indication (e.g., all LEDs 202 turn green and blink twice) may indicate successful unmuting of volume.

As per another example, gesture movement 504 may be interpreted (e.g., by gesture detection 212 of FIG. 2) as a flashlight control command (e.g., flashlight “on” or flashlight “off”), which may allow a user to select a non-game play feature (e.g., flashlight mode) produced by a light producing device (e.g., LEDs 204 of FIG. 2) of a game play device (e.g., game play device 100 of FIG. 1) and toggle the flashlight mode “on” or “off”. Gesture movement 506 may be interpreted (e.g., by gesture detection 212 of FIG. 2) as a UV light control command (e.g., UV light “on” or UV light “off”), which may allow a user to select a game play feature (e.g., UV mode) produced by a UV light producing device (e.g., those of LEDs 204 of FIG. 2 producing UV light) of a game play device (e.g., game play device 100 of FIG. 1), which may be signaled visibly (e.g., LEDs 204 of FIG. 2 may emit violet light when UV mode is activated). Gesture movement 508 may be interpreted (e.g., by gesture detection 212 of FIG. 2) as a night light control command, which may allow a user to select a non-game play feature (e.g., night light mode). The user may select the appropriate color of the night light mode (e.g., as discussed above in relation to gesture movement 422 of FIG. 4) as well as the duration of the night light (e.g., via appropriate control of an “off timer” sub menu).

It should be noted that by using similar gesture movement detection, a virtually unlimited number of game modes may be effectuated by the detection of the unique gesture movement that may be specific to a particular game mode. As per one example, gesture movement 510 may be interpreted (e.g., by gesture detection 212 of FIG. 2) as a “host game” mode that may initiate a game mode (and roles within the game mode) that are controlled by the game play device that issued the game mode command, which may be signaled visibly (e.g., LEDs 204 of FIG. 2 may twinkle red and orange when “host game” mode is activated) by the game play device (e.g., game play device 100 of FIG. 1) that may be hosting game play.

A subsequent gesture movement (e.g., gesture movements 302 and 308 of FIG. 3) may then be used by the host game play device to toggle through a list of game play modes that may be available (e.g., “quick play”, “duel”, “every wizard for themselves”, “wizard wars”, “unicorn magic”, “wizards vs. fae”, “cryomancers”, “master wizard”, “wizard tourney”, “necromancers”, “soul steal”, “capture the egg”, “protect the mana” etc.). As the user toggles through the list of game play modes, the game play modes may be announced audibly and upon selection (e.g., using gesture 320 as discussed above in relation to FIG. 3) an audible description of the selected game play mode may be initiated. Gesture movement 512 may also be effectuated to trigger an audible description of each game play mode, whereby a description of the game play mode may be audiblized (e.g., via speaker 214 of FIG. 2) such that each participant within proximity to the game play device (e.g., game play device 100 of FIG. 1) may listen to the rules of the particular game play mode selected. Voice files (e.g., uncompressed .wav voice files stored within memory 232 of FIG. 2) may audibilize (e.g., via speaker 214 of FIG. 2) the rules of play.

Once the host of the game play has selected the desired game play mode, subsequent gesture movement 514 may then be used by the host game play device to initiate game play. As per one example, once gesture movement 514 is detected (e.g., by gesture detection 212 of FIG. 2), the selected game play mode may be communicated (e.g., via wireless interface 226 of FIG. 2) by the host game play device to the remainder of game play devices, which may then be confirmed by any one or more of audible, visible and/or tactile feedback (e.g., the LEDs of each participating game play device may emit light that is indicative of the selected game play mode) thereby signaling the start of game play by all game play devices.

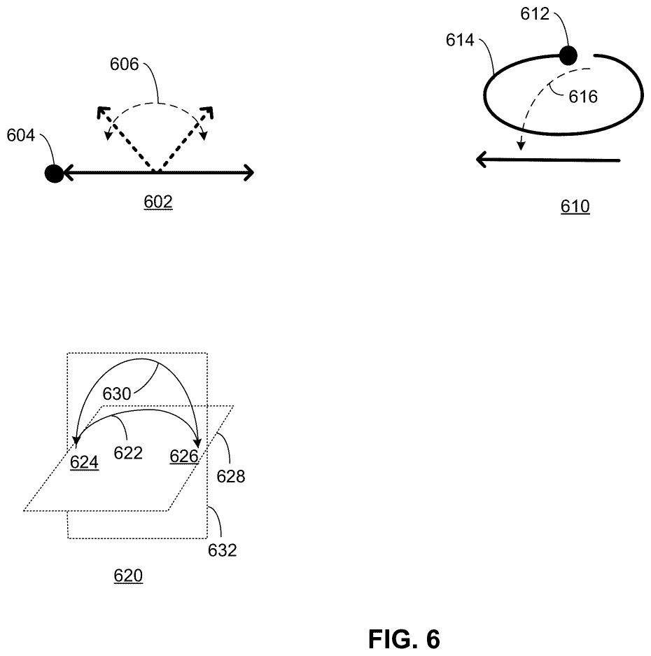

Turning to FIG. 6, various gesture movements are exemplified, which may generally be characterized as wizard spell commands that may be used during game play each having a starting position (e.g., as notated by a black dot) of a particular component of a game play device (e.g., tip 106 of game play device 100), which may then be followed by a unique gesture movement (e.g., as notated by a unique gesture movement indication) originating from the starting position. As per one example, gesture movement 602 may be characterized by starting position 604 followed by back to front movement 606 (e.g., as detected by IMU 208 and gesture detection 212 of FIG. 2).

In one embodiment, gesture movement 602 may be interpreted (e.g., by gesture detection 212 of FIG. 2) as a wizard spell command (e.g., “ice spike”), which may allow a user to direct a concentrated IR emission having a particular distribution angle and range in the direction of an opposing participant of the game play. As per one example, a game play device (e.g., game play device 100 of FIG. 1) may include a processor having I/O control capability (e.g., I/O control 210 of FIG. 2), whereby a data stream may be encoded onto an IR transmission (e.g., an IR transmission from one of IR transceivers 202 of FIG. 2) that may be emitted in a direction indicated by the game play device (e.g., a direction in which tip 106 of game play device 100 is pointed).

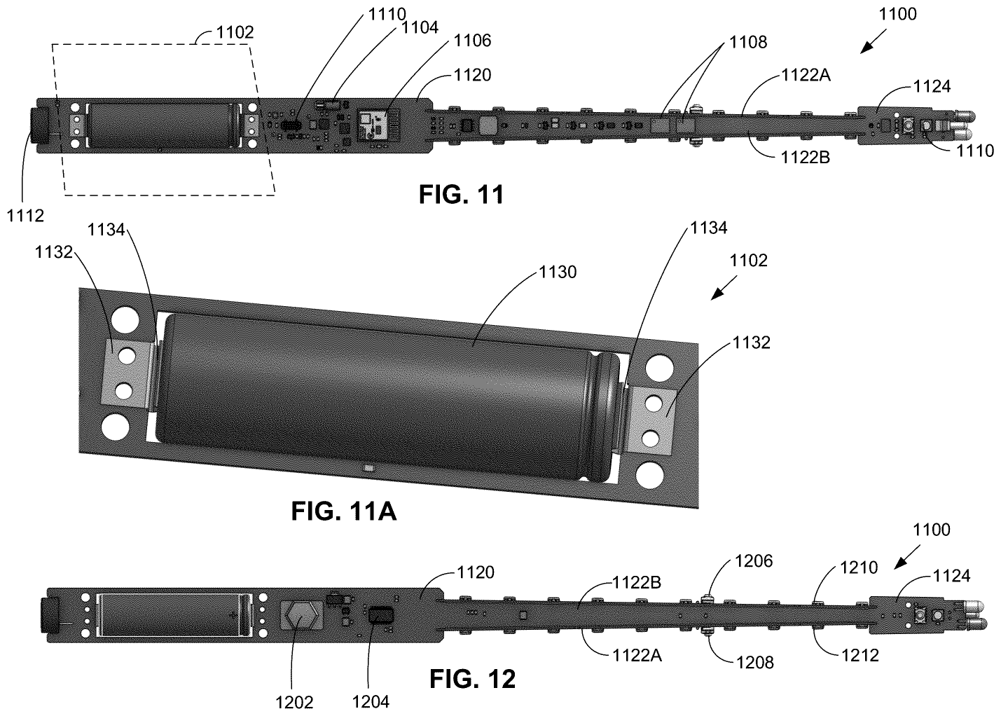

As a result, one or more IR receivers/transceivers (e.g., four IR receivers/transceivers 202 as discussed in more detail below in relation to FIGS. 11-13) of an opposing game play device (e.g., game play device 100) may increase the likelihood of receiving the encoded IR transmission from any angle and to then decode the transmission (e.g., via I/O control 210) as a wizard spell command (e.g., “ice spike”). A memory (e.g., memory 232 of FIG. 2) may store the decoded information, which may include any number of data elements, such as the game device identifier from which the IR transmission was received. After game play terminates, the contents of memory 232 may be downloaded (e.g., via wireless interface 226 of all participating game play devices) into a central game repository, which may then be analyzed to determine the game statistics (e.g., the participant who administered the highest number of “ice spikes” registered by other game participants), which may then be signaled (e.g., audibly and/or visibly) by the game play device as to the individual achievement. If the match play required teams, then the winning team's game play devices may illuminate with victory colors and sounds, while the losing team's game play devices may be muted and remain unlit for an amount of time.

In alternate embodiments, real-time feedback may be provided by the game play device, such that the user of the game play device may gauge his or her performance during game play. As per one example, once an IR receiver/transceiver (e.g., one of IR receivers/transceivers 202 of FIG. 2) of a participating game play device (e.g., game play device 100 of FIG. 1) decodes the receipt of IR-encoded information (e.g., an “ice spike” with source identifying information) as discussed above, the receiving game play device (e.g., game play device 100 of FIG. 1) may address a confirmation of the “ice spike hit” to the source game play device and may transmit the receipt (e.g., via IR transceiver 202 or wireless interface 226) to the source game play device. In response, the source game play device may provide confirmation of the successful delivery of the IR transmission to the user of the source game play device via any number of visible, audible and/or tactile means. Accordingly, the user of the source game play device may be able to receive near real-time feedback as to the scored “ice spike hit” so as to provide a more effective immersion of the user into the game play experience.

Similarly, gesture movement 610 may be characterized by starting position 612 followed by circular movement 614 and downward movement 616 relative to starting position 604 (e.g., as detected by IMU 208 and gesture detection 212 of FIG. 2). In one embodiment, gesture movement 610 may be interpreted (e.g., by gesture detection 212 of FIG. 2) as a wizard spell command (e.g., “fireball”), which may allow a user to direct a scattered IR emission having a particular distribution angle and range in the direction of an opposing participant of the game play. As per one example, a game play device (e.g., game play device 100 of FIG. 1) may include a processor having I/O control capability (e.g., I/O control 210 of FIG. 2), whereby a data stream may be encoded onto an IR transmission (e.g., an IR transmission from one of IR transceivers 202) that may be emitted in a direction indicated by the game play device (e.g., a direction in which tip 106 of game play device 100 is pointed).

As a result, one or more IR receivers/transceivers (e.g., four IR receivers/transceivers 202 as discussed in more detail below in relation to FIGS. 11-13) of an opposing game play device (e.g., game play device 100) may increase the likelihood of receiving the encoded IR transmission from any angle and to then decode the transmission (e.g., via I/O control 210) as a wizard spell command (e.g., “fireball”). A memory (e.g., memory 232 of FIG. 2) may store the decoded information, which may include any number of data elements, such as the particular wizard spell command, intensity and the game device identifier from which the IR transmission was received. In one embodiment, the encoded intensity of the “fireball” may be increased by repeated circular movements 614 prior to executing downward movement 616 to increase the damaging effects of the “fireball” spell.

After game play terminates, the contents of memory 232 may be downloaded (e.g., via wireless interface 226 of all participating game play devices) into a central game repository, which may then be analyzed to determine the game statistics (e.g., the participant who administered the highest number of “fireballs” registered by other game participants), which may then be signaled (e.g., audibly and/or visibly) by the game play device as to the individual achievement. If the match play required teams, then the winning team's game play devices may illuminate with victory colors and sounds, while the losing team's game play devices may be muted and remain unlit for an amount of time.

In alternate embodiments, real-time feedback may be provided by the game play device such that the user of the game play device may gauge his or her performance during game play. As per one example, once an IR receiver/transceiver (e.g., one of IR receivers/transceivers 202 of FIG. 2) of a participating game play device (e.g., game play device 100 of FIG. 1) decodes the receipt of IR-encoded information (e.g., a “fireball” with source identifying information) as discussed above, the receiving game play device (e.g., game play device 100 of FIG. 1) may address a confirmation of the “fireball hit” to the source game play device and may transmit the receipt (e.g., via IR transceiver 202 or wireless interface 226) to the source game play device. In response, the source game play device may provide confirmation of the successful delivery of the IR transmission to the user of the source game play device via any number of visible, audible and/or tactile means. Accordingly, the user of the source game play device may be able to receive near real-time feedback as to the scored “fireball hit” so as to provide a more effective immersion of the user into the game play experience.

Gesture movement 620 may, for example, be used by the user to effectuate a “shield” gesture that may be effective to shield the user from effective hits that may be scored by the spells of other game play participants. Shield gesture 620 may be initiated, for example, by transcribing an arc (e.g., arc 622) with a game play device originating from starting position 624 (e.g., to the left of the user) and terminating at ending position 626 (e.g., to the right of the user) substantially within a single plane (e.g., X-Y plane 628). Shield gesture 620 may then be completed by transcribing an arc (e.g., arc 630) with a game play device originating from starting position 626 (as a continuing movement from the end of arc 622) and terminating at ending position 624 (after which the game play device is held motionless for a few seconds) substantially within a single plane (e.g., X-Z plane 632) that may be substantially perpendicular to plane 628. During game play, feedback (e.g., audible, visible and/or haptic effects) may be used to differentiate between hits on shields versus hits on unshielded game play participants. Blocking with a shield may yield increased points for the defender with decreased points for the corresponding attacker. In alternate game play modes, the shield may simply prevent loss of life or life points.

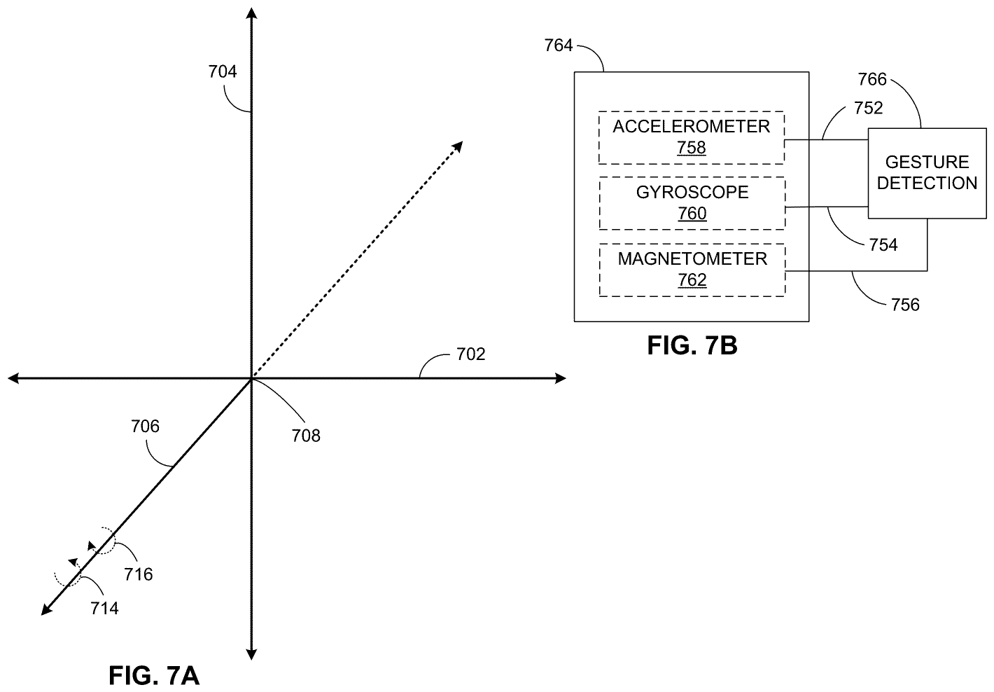

As discussed above, gesture movements of a game play device (e.g., as directed by a user of game play device 100 of FIG. 1) may be detected (e.g., by IMU 208 and gesture detection 212 of FIG. 2) from within an interior of the game play device. Such gesture movements may be defined through the use of a coordinate system as exemplified in FIG. 7A, whereby the orientation of a game play device (e.g., game play device 100 of FIG. 1) may be described in three-dimensional space at any given time in terms of a set of vectors 702, 704 and 706 emanating from origin 708. It should be noted that virtually any orientation of vectors 702, 704 and 706 and origin 708 relative to the game play device may be achieved by the particular placement of IMU 208 within the game play device in relation to the specific coordinate frame relative to the game play device.

Turning to FIG. 7B, for example, IMU 764 (e.g., as discussed above in relation to IMU 208 of FIG. 2) may be disposed within a game play device (e.g., game play device 100 of FIG. 1) so as to define the coordinate frame of the game play device as exemplified in FIG. 7A. Further, data indicative of the movement(s) of the game play device within the coordinate frame may be derived from the data provided by any one or more of accelerometer 758, gyroscope 760 and/or magnetometer 762 of IMU 764. The movement(s) of the game play device may then be further construed by gesture detection 766 (e.g., as discussed above in relation to gesture detection 212 of FIG. 2) as pertaining to a particular gesture such as those discussed above in relation to FIGS. 3-6.

Movement(s) of the game play device may be construed within its coordinate frame as simple gestures that may consist of a single orientation followed by a single motion such as those discussed above, for example, in relation to gestures 302, 308, 314 and 320 of FIG. 3. Other gestures may instead be categorized as complex gestures that may consist of a set of gesture steps each defining one or more movements within the coordinate frame which when chained together may form a complex gesture (e.g., shield gesture 620 or fireball gesture 610).

Gesture detection data 752, 754 and 756 may be received periodically (e.g., at a 400 cycle per second polling rate via processor 206 of FIG. 2) by gesture detection 766 from any one or more of accelerometer 758, gyroscope 760 and magnetometer 762, respectively, of IMU 764. Triaxial accelerometer 758 may, for example, provide linear acceleration data 752 within the coordinate frame of the game play device that may either include or exclude the effects of gravity, whereas triaxial gyroscope 760 may, for example, provide angular velocity data 754 within the coordinate frame of the game play device. Magnetometer 762, on the other hand, may provide data 756 that may be indicative of the orientation of the coordinate frame of the game play device relative to magnetic north.

Table 1 exemplifies mapping of data received from accelerometer 758 (e.g., Data Types 1-3 of Table 1) and gyroscope 760 (e.g., Data Types 4-6 of Table 1) into perceived movements of the game play device.

TABLE 1

| DATA TYPE | PERCEIVED MOVEMENT | DATA |
|---|---|---|
| 1 | Pan left/Pan right | −ACC₇₀₂/+ACC₇₀₂ |
| 2 | Pan down/Pan up | −ACC₇₀₄/+ACC₇₀₄ |
| 3 | Pan forward/Pan backward | −ACC₇₀₆/+ACC₇₀₆ |
| 4 | Rotate up/Rotate down | +GYR₇₀₂/−GYR₇₀₂ |
| 5 | Rotate left/Rotate right | +GYR₇₀₄/−GYR₇₀₄ |
| 6 | Rotate wrist | +GYR₇₀₆/−GYR₇₀₆ |

For example, a game play device (e.g., game play device 100 of FIG. 1) may be moved such that one component of the game play device (e.g., tip 106 of FIG. 1) may be pointing along vector 702 while another component of the game play device (e.g., cap 110 of FIG. 1) points in a direction opposite to vector 702 (e.g., game play device 100 is pointing to the right) such that accelerometer 758 may yield positive-valued, static linear acceleration data 752 along vector 702 (e.g., +ACC₇₀₂) to indicate a game play device movement trending to the right. A game play device trending to the left may similarly yield negative-valued, static linear acceleration data 752 (e.g., −ACC₇₀₂) from accelerometer 758.

A game play device (e.g., game play device 100 of FIG. 1) may instead be moved such that one component of the game play device (e.g., tip 106 of FIG. 1) may be pointing along vector 704 while another component of the game play device (e.g., cap 110 of FIG. 1) points in a direction opposite to vector 704 (e.g., game play device 100 is pointing upward) such that accelerometer 758 may yield positive-valued, static linear acceleration data 752 along vector 704 (e.g., +ACC₇₀₄) to indicate movement of a game play device trending upward. A game play device trending downward may similarly yield negative-valued, static linear acceleration data 752 (e.g., −ACC₇₀₄) from accelerometer 758.

A game play device (e.g., game play device 100 of FIG. 1) may instead be moved such that one component of the game play device (e.g., tip 106 of FIG. 1) may be pointing along vector 706 while another component of the game play device (e.g., cap 110 of FIG. 1) points in a direction opposite to vector 706 (e.g., game play device 100 is pointing backward over the user's shoulder) such that accelerometer 758 may yield positive-valued, static linear acceleration data 752 along vector 706 (e.g., +ACC₇₀₆) to indicate a game play device trending backward. A game play device trending forward may similarly yield negative-valued, static linear acceleration data 752 (e.g., −ACC₇₀₆) from accelerometer 758.

Angular velocity data may be provided by gyroscope 760 and may be utilized by gesture detection 766 to sense a rate of change in angular position of a game play device (e.g., game play device 100 of FIG. 1) as the game play device rotates in an upward or downward direction within the coordinate frame of FIG. 7A about axis 702. As per one example, a change in orientation of a game play device as it rotates upward about axis 702 may yield positive-valued, angular velocity data (e.g., +GYR₇₀₂), whereas a change in orientation of a game play device may yield negative-valued, angular velocity data (e.g., −GYR₇₀₂) as it rotates downward about axis 702.

Alternately, angular velocity data may be provided by gyroscope 760 and may be utilized by gesture detection 766 to sense a rate of change in angular position of a game play device (e.g., game play device 100 of FIG. 1) as the game play device rotates in a leftward or rightward direction within the coordinate frame of FIG. 7A about axis 704. As per one example, a change in orientation of a game play device as it rotates leftward about axis 704 may yield positive-valued, angular velocity data (e.g., +GYR₇₀₄), whereas a change in orientation of a game play device may yield negative-valued, angular velocity data (e.g., −GYR₇₀₄) as it rotates rightward about axis 704.

IMU 208 may be capable of expressing orientations of a game play device in the form of quaternions that may be generated by fusing accelerometer 758 and gyroscope 760 output data 752 and 754, respectively. Equations (1)-(3) represent expressions stated in terms of such quaternions, which when resolved by gesture detection 766 (e.g., as discussed above in relation to gesture detection 212 of FIG. 2) may produce values for pitch, roll and yaw, respectively, of a game play device as follows:

pitch=−sin(2*(quadᵢ*quatₖ−quatᵣ*quatⱼ)) (1)

roll=tan⁻¹(2*(quatᵣ*quadᵢ+quatⱼ*quatₖ),quatᵣ*quatᵣ−quadᵢ*quadᵢ−quatⱼ*quatⱼ+quatₖ*quatₖ) (2)

yaw=tan⁻¹(2*(quadᵢ*quatⱼ+quatᵣ*quatₖ),quatᵣ*quatᵣ+quadᵢ*quadᵢ−quatⱼ*quatⱼ−quatₖ*quatₖ) (3)
where quatᵣ is the quaternion scalar component and quatᵢ, quatⱼ, quatₖ are the quaternion unit vectors. Values for pitch, roll and yaw may then be converted to degrees by multiplying each respective radian value by

$$\frac{180}{π} ( \frac{degrees}{radian} ) . \qquad ( 4 )$$

In order to mitigate the effects of erroneous or extreme variation in the data that may be received from accelerometer 758 and gyroscope 760, an exponential moving average (EMA) filter may be utilized, the code snippet of which may be exemplified by the for-loop of equation (5):

$$for ( i = 0 ; i < num\_vals ; i ++ ) \\ filt\_vals [ i ] = ( 1 - S ) * filt\_vals [ i ] + S * raw\_vals [ i ] ; \qquad ( 5 )$$

where filt_vals is a one-dimensional array having a variable number (num_vals) of filtered data values and raw_vals is a one-dimensional array having the same number of values employed to contain the most recently obtained raw data from accelerometer 758 and/or gyroscope 760. S may be a smoothing factor employed by the EMA filter to weight the most recent raw data, raw_vals[i], while the value of 1-S may be used to weight the previously filtered data, filt-vals[i]. In one embodiment, smoothing factor S may be selected to apply greater weight and thereby more significance to the most recent raw data as compared to previously filtered data. Conversely, smoothing factor S may be selected to apply greater weight and thereby more significance to the previously filtered data as compared to the most recent raw data.

The values computed by equations (1)-(3) above may similarly be subjected to a variation of the EMA filter of equation (5) whose operation and execution within gesture detection 766 may be exemplified by the pseudo-code of equation (6) as discussed in more detail below:
If no verticality or wraparound, (6)
   then filter roll and yaw values normally;
else if wraparound, but no verticality,
   then do not filter roll and yaw values but keep track of yaw direction;
else if verticality,
   then if entering vertical,
      store previous yaw value;
   else if exiting vertical,
      set roll/yaw values directly equal to raw values
Always filter pitch values.

The need for equation (6) may be required when the value computed for pitch (e.g., as in equation (1) above) indicates that the game play device is oriented in a vertical or near vertical position (i.e., verticality) thereby rendering the roll, pitch and/or yaw values computed by equations (1)-(3) unreliable.

The pseudo-code exemplified by equation (6) may be further useful when modulus arithmetic is necessary to describe the orientation of the game play device as it traverses modulus-if boundaries within the coordinate frame of FIG. 7A. Accelerometer data (e.g., Data Type 3 of Table 1) may, for example, be generated as the game play device pans backward and forward yielding positive values between degrees as the game play device's orientation includes a directional component along vector 706 and yielding negative values between 0-180 degrees as the game play device's orientation includes a directional component along a direction that is opposite to vector 706. In so doing, as the game play device pans forward and backward, the sign and incremental change in Data Type 3 may reverse from increasing negative to decreasing positive values (e.g., . . . −178, −179, −180/180, 179, 178 or from decreasing negative to increasing positive values (e.g., . . . −2, −1, −0/0, 1, 2 through operation of modulus-if arithmetic defined herein as wraparound.

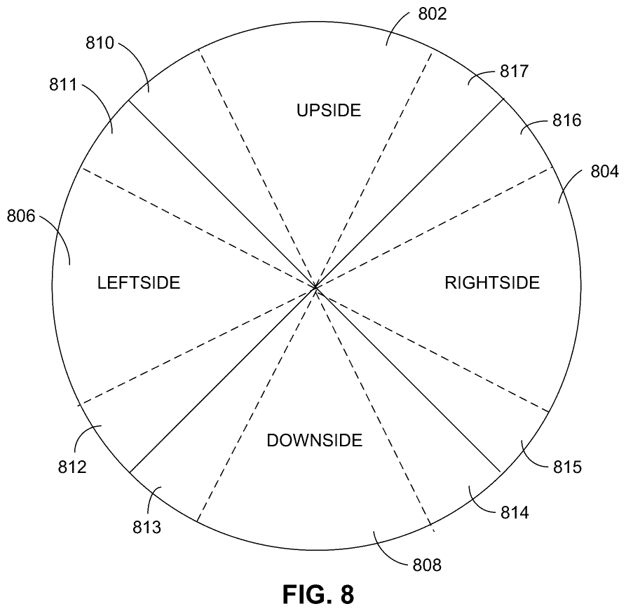

As discussed above in relation to equation (2), roll values may be calculated and subsequently used by gesture detection 766 to determine a magnitude of roll exhibited by a game play device about axis 706, such that in one embodiment a roll value about axis 706 may be calculated to be within 0 to 360 degrees (0 to 2π radians) in direction 716 or conversely a roll value about axis 706 may be calculated to be within −0 to −360 degrees (−0 to −2π radians) in direction 714. As per one example, the game play device may be held by a user such that one end of the game play device (e.g., tip 106 of game play device 100 of FIG. 1) may be pointing in a direction parallel to vector 706 (e.g., either backward over the user's shoulder or forward away from the user) with a roll value equal to 0 degrees (e.g., a roll value that as discussed in more detail below exists within upside roll quadrant 802 of FIG. 8) as may be calculated by equation (2). In such an instance, the vectors orthogonal to vector 706 (e.g., vectors 702 and 704) may exhibit the orthogonal relationship as exemplified in FIG. 7A whereby accelerometer data 752 and gyroscope data 754 may be used by gesture detection 766 as is without the need for normalization as discussed in more detail below.

It can be seen, however, that as the roll value changes about axis 706 in either direction 714 or 716, vectors 702 and 704 must also rotate in equal proportion and direction as compared to the value of roll so as to maintain the orthogonality of axes 702, 704 and 706. In so doing, absolute motion as detected by gesture detection 766 may be made to appear fixed within the game play device's frame of reference by modifying the direction of vectors 702 and 704 in proportion to the roll value thereby substantially negating the roll value (e.g., a process described herein as normalization).

As per one example, a calculation of roll per equation (2) by gesture detection 766 may indicate that the game play device has increased its roll value from 0 to 90 degrees along vector 706 (e.g., pointing backward over the user's shoulder) in direction 714 (e.g., a roll value that as discussed in more detail below may exist within rightside roll quadrant 804 of FIG. 8A). In order to maintain the orthogonality of vectors 702 and 704 within the game play device's frame of reference with respect to its new roll value, vectors 702 and 704 may also be rotated (i.e., normalized) 90 degrees in direction 714 by gesture detection 766.

Accordingly, linear acceleration as measured by accelerometer 758 along vector 702 (+ACC₇₀₂) may be normalized by gesture detection 766 to the acceleration value as measured along vector 704 (+ACC₇₀₄) because the acceleration vector rotates from an axis parallel to vector 702 to an axis parallel to vector 704 due to the 90-degree change in roll value to rightside roll quadrant 804. Furthermore, linear acceleration as measured by accelerometer 758 along vector 704 may be normalized by gesture detection 766 to an inverted acceleration value as measured opposite vector 702 (−ACC₇₀₂) because the acceleration vector rotates from an axis parallel to vector 704 to an axis parallel, but opposite to, vector 702. The corresponding angular velocity measurements about axes 702 and 704, +GYR₇₀₂ and +GYR₇₀₄, respectively, may similarly be normalized by gesture detection 766 to +GYR₇₀₄ and −GYR₇₀₂, respectively, due to the 90-degree change in roll value to rightside roll quadrant 804.

Turning to FIG. 8, all possible values of roll as calculated by equation (2) may be described graphically as existing in one of four roll quadrants (e.g., upside roll quadrant 802, rightside roll quadrant 804, leftside roll quadrant 806 and downside roll quadrant 808). Values for accelerometer data 752 and gyroscope data 754 may be normalized to one of four roll value quadrants as discussed above and as tabulated in Table 2.

TABLE 2

| Normalized | Upside | Leftside | Downside | Rightside |
|---|---|---|---|---|
| ACC₇₀₂ | ACC₇₀₂ | −ACC₇₀₄ | −ACC₇₀₂ | ACC₇₀₄ |
| ACC₇₀₄ | ACC₇₀₄ | ACC₇₀₂ | −ACC₇₀₄ | −ACC₇₀₂ |
| ACC₇₀₆ | ACC₇₀₆ | ACC₇₀₆ | ACC₇₀₆ | ACC₇₀₆ |
| GYR₇₀₂ | GYR₇₀₂ | −GYR₇₀₄ | GYR₇₀₂ | GYR₇₀₄ |
| GYR₇₀₄ | GYR₇₀₄ | GYR₇₀₂ | −GYR₇₀₄ | −GYR₇₀₂ |
| GYR₇₀₆ | GYR₇₀₆ | GYR₇₀₆ | −GYR₇₀₆ | GYR₇₀₆ |

Through the process of normalization, absolute motion of the game play device may be detected as if the game play device was in upside roll quadrant 802 regardless of the game play device's actual roll value. As per one example, the roll value of a game play device may have increased by 180 degrees from upside roll quadrant 802 in either direction 714 or 716 to downside roll quadrant 808 as determined by equation (2). As such, gesture detection 766 may normalize accelerometer data 752 and gyroscope data 754 to downside roll quadrant 808 by inverting accelerometer data 752 and gyroscope data 754 per Table 2 so that any movements of the game play device may be registered as if the game play device was oriented in upside quadrant 802 despite its actual orientation in downside quadrant 808.

Operation of the normalization process across roll quadrant boundaries may require modification of the minimum and maximum requirements for gyroscope data 754 as received from gyroscope 760 prior to movement detection. In particular, if the game play device exhibits a roll value that resides within any one of transition regions 810-817, then gyroscopic data 754 may tend to exhibit significantly reduced magnitudes (e.g., about 50% reduction) as compared to the magnitudes of gyroscopic data 754 generated when the game play device's roll value does not reside within any one of transition regions 810-817. Accordingly, proper manipulation of these reduced gyroscopic data magnitudes may be required to increase the accuracy of the corresponding gesture detection as discussed in more detail below.

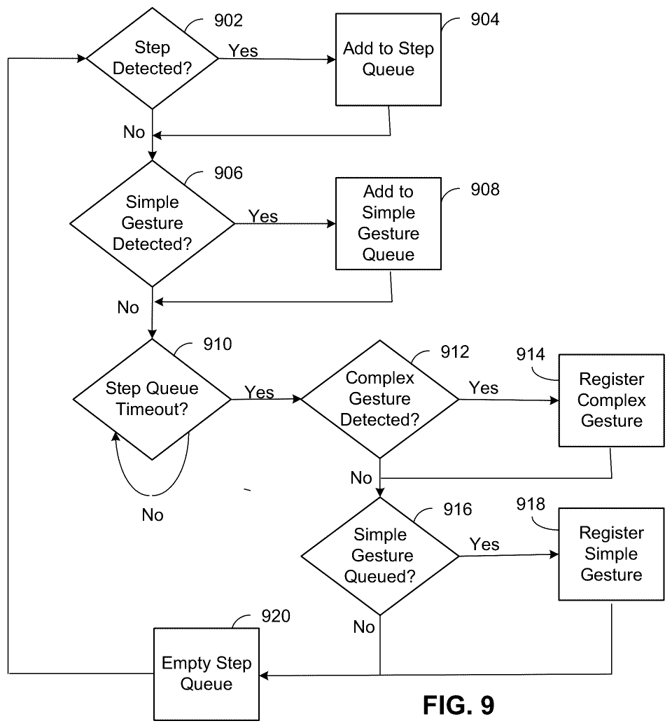

Turning to FIG. 9, an exemplary flow diagram as executed by a gesture detection algorithm (e.g., as discussed above in relation to gesture detection 212 of FIG. 2 and gesture detection 766 of FIG. 7) is exemplified. Decision block 902 includes a system of checks for a variety of possible step movements as exemplified in Tables 3 and 4.

TABLE 3

| FORWARD FACING STEPS | MOVEMENT DESCRIPTION |
|---|---|
| Step Left | Game play device moves left |
| Step Right | Game play device moves right |
| Step Up | Game play device moves up |
| Step Down | Game play device moves down |
| Step Up Left | Game play device moves |
| | diagonally up and to the |
| | left |
| Step Up Right | Game play device moves |
| | diagonally up and to the |
| | right |
| Step Down Left | Game play device moves |
| | diagonally down and to the |
| | left |
| Step Down Right | Game play device moves |
| | diagonally down and to the |
| | right |

TABLE 4

| VERTICAL FACING STEPS | MOVEMENT DESCRIPTION |
|---|---|
| Step to Vertical | Game play device moves |
| | forward up to vertical |
| Step Forward from Vertical | Game play device moves from |
| | vertical to forward |
| Step Backward from Vertical | Game play device moves from |
| | vertical to backward (e.g., |
| | backward over the shoulder) |
| Step Right from Vertical | Game play device moves from |
| | vertical to pointing right |
| Step Left from Vertical | Game play device moves from |
| | vertical to pointing left |

Table 3 lists exemplary step movements performed by a user while handling a game play device (e.g., game play device 100 of FIG. 1) as the normalized orientation of the game play device remains in a direction that is substantially opposite to and parallel with vector 706 (e.g., pointed forward away from the user). Table 4 lists exemplary step movements performed by a user while handling a game play device (e.g., game play device 100 of FIG. 1) as the normalized orientation of the game play device transitions between a direction that is substantially parallel to vector 704 (e.g., pointed vertically upward) and a direction that is substantially parallel to vector 706 (e.g., either pointed forward away from the user or pointed backward over the user's shoulder) or a direction that is substantially parallel to vector 702 (e.g., either pointed to the left or to the right).

Prior to the execution of decision step 902, a determination of the game play device's roll value may be made to determine whether the roll value resides within any one of transition regions 810-817 as discussed above in relation to FIG. 8. If so, then processing of the minimum/maximum values of data 754 received from gyroscope 760 by gesture detection 766 may be modified in accordance with the roll value in order to compensate for the reduced gyroscopic measurements received while the game play device's roll value resides within one of transition regions 810-817.

In one embodiment, for example, once accelerometer data 752 and gyroscope data 754 have been filtered in accordance with equation (5), minimum and maximum values for each may be tracked across a timespan (e.g., approximately 100 ms) and stored for processing. Accordingly, while a user is subjecting the game play device to movement, only the extreme values of the filtered accelerometer data 752 and gyroscope data 754 may be tracked during the movement. Any of the min/max values that meet magnitude thresholds for any particular movement (e.g., a simple or complex gesture) may then be registered. Once registered, the tracked min/max values may be reset to zero in preparation for detection of the next movement.

Min/max values may be tracked for longer periods of time if, for example, a particular movement cannot be characterized as either a simple or a complex gesture (e.g., the movement involves multiple directions but is not made up of multiple steps). In this instance, extreme values of filtered accelerometer data 752 and gyroscope data 754 may be tracked for a longer duration adequate to detect such a hybrid movement (e.g., overhead gesture 514 of FIG. 5). In this instance, longer tracking durations for each detected direction may be required since premature resetting of the tracked values may preclude detection of the hybrid movements.

Further preprocessing may be required prior to execution of decision step 902 when the vertical facing steps of Table 4 are to be detected. As discussed above in relation to equation (3), for example, yaw values may be unreliable when the game play device is placed into a vertical, or near vertical, orientation. As such, changes in yaw are stored prior to entering a vertical orientation and subsequent to exiting a vertical orientation and are then subsequently compared and used during decision step 902.

During execution of decision step 902, pitch and yaw values of equations (1) and (3), respectively, may be filtered and stored in respective pitch and yaw queues so as to determine a general trend in magnitude and direction while minimizing the effects of spurious data. Accordingly, a determination may be made as to whether magnitudes of pitch and yaw values are increasing, decreasing or substantially stable and whether directions of pitch and yaw values are changing. Furthermore, the rates of change of both pitch and yaw may be calculated from the data contained within the pitch and yaw queues to determine which quantity is changing more with respect to time.

The roll, pitch and yaw magnitude/directional processing as discussed above may be useful to reduce certain spurious effects that may be experienced during gesture detection. For example, EMA filtering may be used to remove spurious directional data (e.g., direction of movement reported opposite to the actual direction of movement) that may result from deceleration of movement of a game play device. Yaw and pitch rate processing may be useful, for example, when confirming that purely left/right movements include greater yaw rates than pitch rates. Absolute values of pitch may be used, for example, to accurately determine the verticality of the game play device thereby producing knowledge that the yaw calculations of equation (3) may yield anomalous results should verticality exist.

As per an example for clarification of the discussion above, the code snippet of Table 5 exemplifies step processing checks that may be used by gesture detection 766 during decision 902 of FIG. 9 to verify whether the “Step Up Left” forward facing step of Table 3 has occurred.

TABLE 5

| Pseudo Code | Comment |
|---|---|
| if maxGyroData [1] > | Check to confirm GYR₇₀₂ > diagonal |
| diag_maxGyrY_req | requirement |
| if maxGyroData [2] > | Check to confirm GYR₇₀₄ > diagonal |
| diag maxGyrY_req | requirement |
| if yaw_dir == 1 | Check to confirm yaw direction is |
| | left |
| if pitch_dir == 1 | Check to confirm pitch direction is |
| | up |
| if yaw_rate > 0.35 | Check to confirm medium yaw rate |
| if pitch_rate > 0.35 | Check to confirm medium pitch rate |
| If abs (pitch) < CONST | Check to confirm absolute value of |
| | pitch is not entering verticality |

Once Step Up Left decision 902 passes the checks of Table 5, the Step Up Left step may be added to the step queue as in process 904, but only if the step has not been previously detected within an amount of time (e.g., 100 ms). As discussed above, for example, a 100 ms step timer may be set each time a step has been detected such that any duplicate steps detected before the step timer has expired may not be further added to the step queue to avoid redundant detection of steps.

If the detected step does not form an intermediate step of a simple gesture (e.g., the Step Up Left movement will not be found to form any portion of simple gestures 302, 308, 314 and 320 of FIG. 3), then decision 906 evaluates negatively and the step queue timer may be checked in decision 910 to determine whether the game play device is stable (e.g., expiration of the step queue timer indicates that the game play device has stabilized).

Once stabilized, decision 912 parses through the step queue to determine whether any of the detected steps can be linked to form a complex gesture. If so, then the complex gesture may be registered as in process 914 and any previously detected simple gestures (e.g., as detected by decision 906) may then be cleared from the simple gesture queue (e.g., as added to by process 908). If no complex gestures may be registered, then decision 916 may determine whether any simple gestures have been detected and stored. If so, then the simple gesture may be registered as in process 918. The step queue may be emptied as in process 920, which then returns gesture detection processing to step detection as in decision 902.

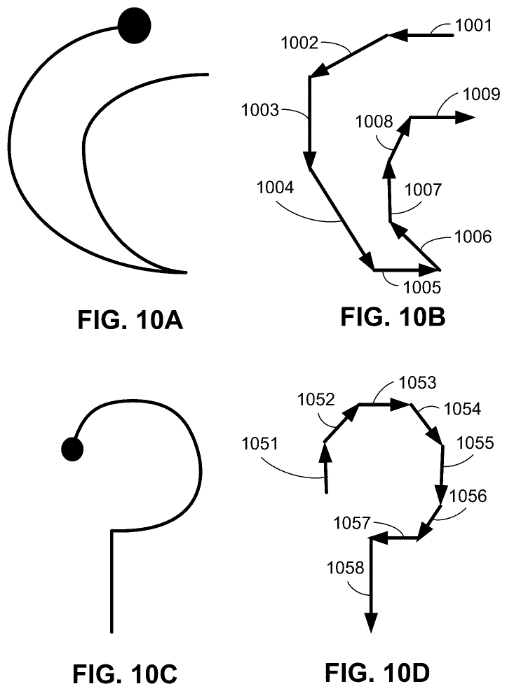

Turning to FIGS. 10A-10D, complex gesture processing (e.g., via decision 912 of FIG. 9) may be further exemplified as the processing of sets of predetermined sequences, which when combined end to end may form a complex gesture. FIG. 10A exemplifies one such complex gesture (e.g., as discussed above in relation to complex gesture 508 of FIG. 5) which may, for example, be approximated by nine individual sequences 1001 through 1009 as shown in the template of FIG. 10B that may be itemized in Table 6 as comprising a series of preselected forward facing steps.

TABLE 6

| Step Sequence | Step Description |
|---|---|
| 1001 | Step Left |
| 1002 | Step Down_Left |
| 1003 | Step Down |
| 1004 | Step Down_Right |
| 1005 | Step Right |
| 1006 | Step Up_Left |
| 1007 | Step Up |
| 1008 | Step Up_Right |
| 1009 | Step Right |

FIG. 10C exemplifies another such complex gesture (e.g., as discussed above in relation to complex gesture 512 of FIG. which may, for example, be approximated by eight individual sequences 1051 through 1058 as shown in the template of FIG. 10D that may be itemized in Table 7 as comprising a series of preselected forward facing steps.

TABLE 7

| Step Sequence | Step Description |
|---|---|
| 1051 | Step Up |
| 1052 | Step Up_Right |
| 1053 | Step Right |
| 1054 | Step Down_Right |
| 1055 | Step Down |
| 1056 | Step Down_Left |
| 1057 | Step Left |
| 1058 | Step Down |

Each series of preselected sequences 1001-1009 and 1051-1058 may, for example, be stored within a memory of a game play device (e.g., memory 232 as discussed above in relation to FIG. 2) as templates of step components. Such templates may then be compared to a step queue of detected user input steps (e.g., as discussed above in relation to process 904 of FIG. 9) to determine a proximity difference between each step component of the template and each user input step within the step queue.

In one embodiment, such proximity differences may be characterized as weighted Levenshtein Distances and stored into a table that may itemize the degree of error that may exist between each user input step and each corresponding template step. As per an example, the weighted Levenshtein Distance may indicate a high degree of error between a user implemented “Step Right” component when compared to a corresponding “Step Left” template component. Conversely, the weighted Levenshtein Distance may indicate a low degree of error between a user implemented “Step Right” component when compared to a corresponding “Step Up Right” template component. Further, weighted Levenshtein Distances may also be recorded for missing and/or additional user input steps.

Once the step queue of detected user input steps has been compared and scored against all templates, the template comparison resulting in the best score (e.g., the lowest Levenshtein Distance score) may be selected as the template that most likely represents the complex gesture intended by the user. The best score may then be compared to a threshold score to determine whether the complex gesture is to be registered (e.g., as discussed above in relation to process 914 of FIG. 9).

It should be noted that decision 912 of FIG. 9 may implement a control scheme that precludes the comparison of the step queue to certain of the stored templates in the interest of time (e.g., to reduce the amount of time required for complex gesture detection) depending upon the operational state of the game play device. As per one example, a control scheme may be implemented that precludes the comparison of the step queue to certain user actions (e.g., casting a “fireball” spell using gesture 610 as discussed above in relation to FIG. 6) when the user of the game play device may instead be navigating control menus within the game play device.

In one embodiment, the movements constituting simple and/or complex gestures may be reversed or mirrored so as to increase the efficacy for specialty (e.g., left-handed) users who may tend to gesture in directions that may be opposite to those of right-handed users. Further, the simple and/or complex gestures may be detected using less rigid detection rules for certain gestures. As per one example, gesture 504 (as discussed below in relation to FIG. 5) exhibits a geometric symmetry that provides points of a star that may be separated by approximately 72 degrees starting with point 503 that points in a particular direction (e.g., parallel to vector 704) followed by the remaining points of the star offset from point 503 by 72, 144, 216, etc. degrees. However, if gesture 504 were to be drawn by a user such that point 503 were not pointing in a direction parallel to vector 704, but rather rotated by a nominal amount (e.g., 15 degrees in a clockwise direction), then so long as the remaining points of the star were also substantially rotated by about 15 degrees in a clockwise direction relative to point 503 then gesture 504 may nevertheless be detected successfully.

In alternate embodiments, the game play device may include a machine-teaching mode that may utilize both simple and complex gesture templates stored within the game play device's memory to teach a user of the game play device how to optimize their movements when attempting to issue gesture commands. For example, the game play device may enter the machine-teaching mode (e.g., via a voice command issued by the user) such that a voice to text converter (e.g., voice transducer 218 as discussed above in relation to FIG. 2) translates the user's voice command to place the game play device into a machine-teaching mode.

The user may then verbally communicate his/her specific learning requirement (e.g., “teach me how to cast a fireball spell”), which then may cause the game play device to recall the template of step components associated with a “fireball” gesture. The game play device may then direct (e.g., via audible, visible or tactile feedback) the user to emulate each step component of the requested gesture by progressively maneuvering the game play device through each step. As the steps progress, the game play device may provide constructive feedback (e.g., audibly, visibly or via haptics) to allow the user to continuously improve his or her skill at effectuating the requested gesture. Such a machine-teaching mode may be made to be active at any time including during game play to correct and/or instruct gesture technique. As such, the machine teaching may act as an artificially intelligent (AI) assistant during the game play to improve the user's performance.

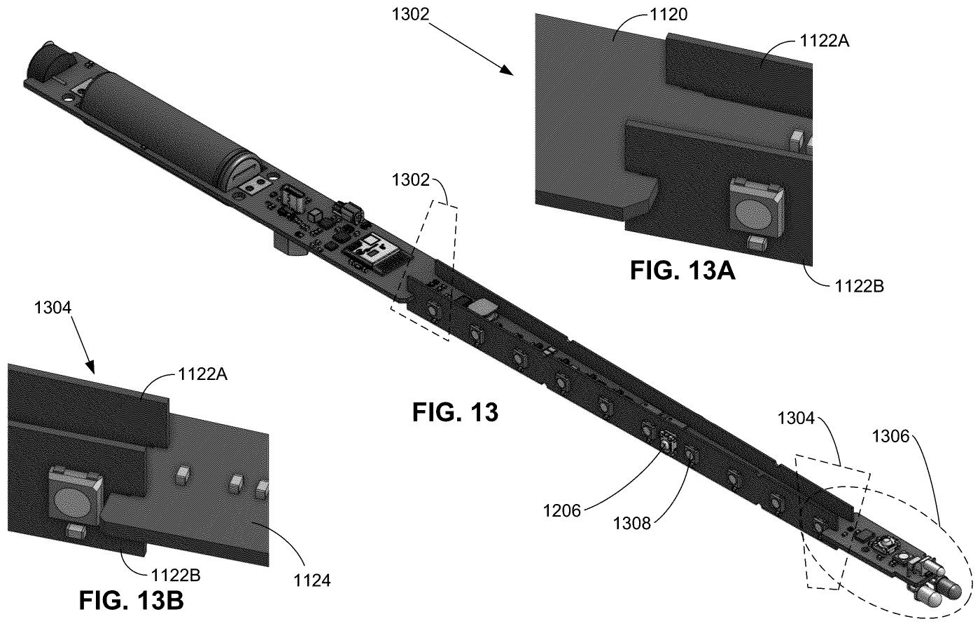

Turning to FIGS. 11-13, various printed circuit board assemblies (PCBAs) are exemplified which may illustrate the physical placement of game play device components (e.g., those components discussed above in relation to block diagram 200 of FIG. 2) within a game play device (e.g., game play device 100 of FIG. 1) that are hidden within the case (not shown) of the game play device. FIG. 11, for example, exemplifies a top isometric view of PCBA 1100, which may include multiple sub-PCBAs (e.g., base PCBA 1120, LED PCBAs 1122A and 1122B and tip PCBA 1124) the electrical/mechanical attachments of which are discussed in more detail below with regard to FIG. 13.

Battery 1130 (e.g., as discussed above in relation to battery 220 of FIG. 2) may be arranged within the game play device along its longitudinal axis on PCBA 1120 such that the weight of battery 1130 may exist within a handle region of the game play device (e.g., enclosed within handle 104 as discussed above in relation to FIG. 1), which may tend to transfer the center of gravity of the game play device closer to handle 104. Battery 1130 may be captured between contacts 1132 that may exhibit spring features 1134 that may exert static friction against battery 1130 to mechanically secure battery 1130 in place while maintaining adequate electrical continuity with the electrodes of battery 1130 and the associated electrically conductive traces of PCBAs 1120-1124. Other components arranged on PCBA 1120 may include speaker 1112 (e.g., as discussed above in relation to speaker 214 of FIG. 2), USB-C port 1110 (e.g., as discussed above in relation to USB-C port 230 of FIG. 2), haptic motor 1104 (e.g., as discussed above in relation to vibration generator 216 of FIG. 2), primary processor 1106 (e.g., as discussed above in relation to processor 206 of FIG. 2), flash memory 1108 (e.g., as discussed above in relation to memory 232 of FIG. 2), which in one embodiment may exist external to processor 206 and one of many (e.g., four) IR receivers/transceivers 1110 (e.g., as discussed above in relation to IR receivers/transceivers 202 of FIG. 2).

Turning to FIG. 12, a bottom isometric view of PCBA 1100 is exemplified, which as discussed above may include sub-PCBAs 1120-1124 and switch 1202 (e.g., as discussed above in relation to On/Off switch 228 of FIG. 2). Secondary processor 1204 (e.g., as discussed above in relation to processor 206 of FIG. 2) may provide additional drive capability for certain I/O components such as LED strings 1210 and 1212 (e.g., LEDs 204 as discussed above in relation to FIG. 2), haptic motor 1104 (e.g., as discussed above in relation to FIG. 11) and IR receivers/transceivers (e.g., as discussed above in relation to IR receivers/transceivers 202 of FIG. 2).

Turning to FIG. 13, mechanical fitment of PCBAs 1120, 1122A, 1122B and 1124 is illustrated in greater detail. Each of PCBAs 1122A and 1122B may, for example, exhibit notches (e.g., voids not shown) on both ends of PCBAs 1122A and 1122B that may be used to accept mechanical insertion of PCBA 1120 (e.g., as shown in magnified view 1302 of FIG. 13A) and mechanical insertion of PCBA 1124 (e.g., as shown in magnified view 1304 of FIG. 13B). Each notch of each PCBA 1122A and 1122B may further exhibit electrically conductive pads (not shown) which may be lap soldered to corresponding electrically conductive terminals (not shown) that may exist on the top and/or bottom sides of PCBAs 1120 and/or 1124 to increase the mechanical efficacy of fitment. Furthermore, each pad of each notch may be electrically connected to power and control signal traces of PCBAs 1122 and 1124 such that power and control signals may be routed between PCBAs 1120, 1122A, 1122B and 1124 as necessary for operation.

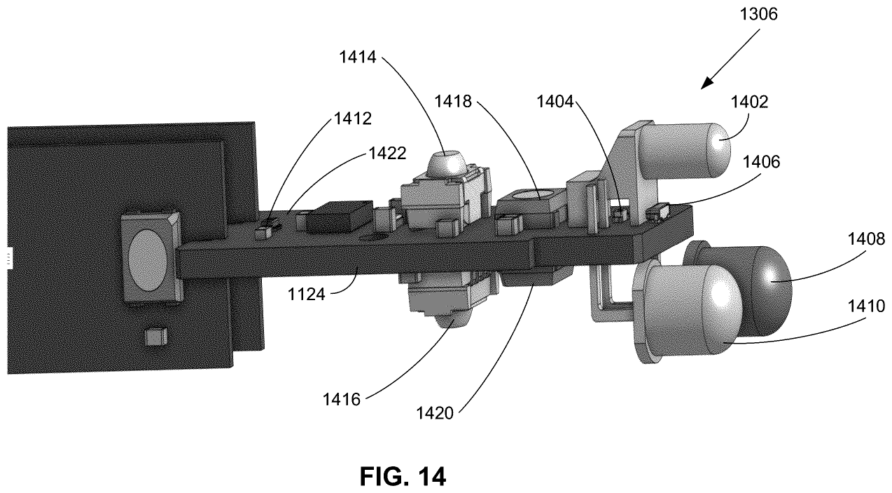

Turning to FIG. 14, a magnified view of section 1306 of FIG. 13 is exemplified in which various components of a game play device may be concentrated to one end (e.g., tip 106 as discussed above in relation to FIG. 1). In one embodiment, various IR emission capability may exist via IR LEDs 1408 and 1410 (e.g., as discussed above in relation to IR receivers/transceivers 202 of FIG. 2), whereby IR LED 1408 may be utilized for short-range IR transmission to effectuate broad (e.g., about a 50 degree distribution) of IR light to implement a “shotgun” like weapon and IR LED 1410 may be utilized for long-range IR transmission to effectuate narrow (e.g., about a 6 degree distribution) of IR light to implement a “sniper” like weapon. IR receivers/transceivers 1414 and 1416 may be diametrically opposed to one another on each side of PCBA 1124 such that targeted IR transmissions from another game play device may be received on either side of PCBA 1124. It should be noted that IR receivers/transceivers 1206 and 1208 as discussed above in relation to FIG. 12 above may also be diametrically opposed to one another so as to provide IR reception capability for any IR transmissions incident upon PCBAs 1122A and/or 1122B.

UV light transmission may, for example, be accomplished via UV emitter 1404 and light pipe 1402 such that UV light emitted by 1404 in a direction that is normal to side 1422 of PCBA 1124 may be emitted from the game play device in a direction that is parallel to side 1422, which in one embodiment effectuates UV light transmission from a tip of the game play device (e.g., tip 106 as discussed above in relation to FIG. 1) outward. Transmission of white light (e.g., in flashlight mode) may be effectuated by white LED 1406. Lastly, LEDs 1418 and 1420 may, for example, be individually addressable and electrically connected to the individually addressable LEDS of LED strings 1212 and 1210 of PCBAs 1122A and 1122B, respectively, as discussed above in relation to FIG. 12.

Other aspects and embodiments of the present invention will be apparent to those skilled in the art from consideration of the specification and practice of the invention disclosed herein. For example, the game play device may be implemented with virtually any form factor (e.g., relay baton) so as to facilitate portability. It is intended, therefore, that the specification and illustrated embodiments be considered as examples only, with a true scope and spirit of the invention being indicated by the following claims.

What is claimed is:

1. A game play device, comprising:
an outer structure formed to mimic a magic wand, the outer structure configured to conceal internal components of the game play device including,
a single inertial measurement unit (IMU) configured to detect movements of the game play device; and
a processor configured to construe the movements as commands, wherein the processor uses the commands to control one or more operational modes of the game play device.

2. The game play device of claim 1, wherein the single IMU generates acceleration and gyroscopic data in response to the detected movements.

3. The game play device of claim 2, wherein the processor is configured to filter the acceleration and gyroscopic data to remove spurious effects.

4. The game play device of claim 3, wherein the processor is configured to compute a roll value from the filtered acceleration and gyroscopic data.

5. The game play device of claim 4, wherein the processor is configured to normalize the detected movements of the game play device to the computed roll value.

6. The game play device of claim 5, wherein the processor is configured to modify processing of the filtered gyroscopic data when the computed roll value resides within a transition region.

7. The game play device of claim 3, wherein the processor is configured to compute a yaw value from the filtered acceleration and gyroscopic data.

8. The game play device of claim 7, wherein the processor is configured to exclude yaw values used for construing command movements while the game play device exhibits verticality.

9. A method of detecting movement of a game play device, comprising:
determining roll, pitch and yaw values using acceleration and gyroscopic data collected within a coordinate frame of a game play device;
filtering at least one of the determined roll, pitch and yaw values;
compensating for reduced magnitudes of the gyroscopic data when the roll value resides within a transition region;
normalizing the accelerometer and gyroscopic data to the determined roll value;
excluding yaw values when the game play device exhibits verticality; and
registering the detected movements as command gestures.

10. The method of claim 9, wherein each of the determined roll, pitch and yaw values are filtered in the absence of verticality and wraparound.

11. The method of claim 9, wherein pitch values are filtered in the absence of verticality.

12. The method of claim 9, wherein registering a command gesture includes adding a detected step to a step queue.

13. The method of claim 12, wherein registering a command gesture further includes parsing each detected step of the step queue.

14. The method of claim 13, wherein registering a command gesture further includes registering a complex gesture if linking the parsed steps creates a complex gesture.

15. The method of claim 13, wherein registering a command gesture further includes registering a simple gesture if linking the parsed steps does not create a complex gesture.

16. A gesture detection system, comprising:
an inertial measurement unit (IMU);
a processor coupled to the IMU, the processor including a gesture detection module coupled to the IMU;
a memory coupled to the gesture detection module, the memory configured to store a sequence of detected gesture steps and a plurality of gesture step templates; and
wherein the gesture detection module is configured to determine a first proximity difference between the sequence of detected gesture steps as compared to at least a first portion of the plurality of gesture step templates.

17. The gesture detection system of claim 16, wherein the sequence of detected gesture steps that minimizes the first proximity difference is registered as a gesture.

18. The gesture detection system of claim 17, wherein a second portion of the plurality of gesture step templates are not selected for comparison depending upon an operational state of the gesture detection system.

19. The gesture detection system of claim 16 wherein the processor is further configured to determine a second proximity difference between a preselected gesture step template and a sequence of gesture steps implemented by a user of the gesture detection system.

20. The gesture detection system of claim 19 wherein the processor is further configured to guide the user through feedback to minimize the second proximity difference.
